(19) United States
(12) Patent Application Publication
(10) Pub. No.: US 2012/0226089 A1
(43) Pub. Date: Sep. 6, 2012

(54) DRY ASH COLLECTOR

(75) Inventor: Robert Lees BARKER, Hockessin, DE (US)

(73) Assignee: COVANTA ENERGY CORPORATION, Fairfield, NJ (US)

(21) Appl. No.: 13/040,076

(22) Filed: Mar. 3, 2011

(51) Int. Cl. B09B 3/00; F23J 1/00

(52) U.S. Cl. 588/256; 126/242

(57) ABSTRACT

A dry ash collector for a combustion system is disclosed. Certain embodiments of the system may contain a reception zone for receiving falling ash from a furnace; an ash zone providing a container for storing falling ash; and an ash seal. Methods for using the dry ash collector and combinations with a full combustion system are also disclosed.

### BACKGROUND OF THE INVENTION

The present invention relates to a dry ash collector which is a component of a commercial waste processing unit. In these units, municipal waste is combusted at high temperatures to oxidize the organic content of the waste, leaving the inorganic content of the waste, also known as the ash content, to be collected and removed from the process for downstream processing or disposal. One or more waste combustion furnaces are used to combust the waste. Aspects of the present invention relate to an ash collector which can be connected to the furnace to receive the ash content of the waste following combustion. In conventional ash collectors (wet ash collectors), the hot ash is immersed in a bath of water to cool the ash (it initially enters the ash collector at temperatures between 300° and 800° F.). Because of the high heat capacity of the ash, other cooling approaches, such as direct contact with cool air, or indirect heat exchange with cooling water, are impractical and uneconomical. A second reason a water bath is used to collect ash from waste combustion furnaces is to provide a water seal for the furnace to prevent uncontrolled air from entering the furnace. Thus prior art ash collectors utilize immersion cooling (placing the ash in a bath of water) to cool off the ash. The problem with immersion cooling of the ash is the ash becomes saturated with water. This of course makes the recovered ash stream much heavier (can be as much as 30% heavier) due to the residual water content that remains with the ash. Since the price the municipal waste facilities need to pay to dispose of the recovered ash is often determined (at least in part) by the weight of the ash, reducing the weight of the ash could generate cost savings to the municipal waste facility.

### RELATED PRIOR ART

AshTech Corporation of Cleveland, Ohio and Clyde Bergemann of South Yorkshire, UK offer a commercial submerged chain conveyor system for removing bottom ash from stoker/grate furnaces that handle municipal solid waste. These systems consist of a water filled trough equipped with a submerged chain conveyor. The conveyor flights drag ash along an inclined trough wherein water from the ash is drained back into the trough and dewatered ash is dropped off for disposal. The company's web site: http://www.ashtechcorp.com/SubmergedChainConveyorSystems.htm claims that it can provide systems with low water use with zero water discharge. However, embodiments of the present invention feature lower water usage than the Ashtec system, because the Ashtec system still relies upon waste immersion system, and while drying the bottom ash in the inclined trough may help remove some of the excess moisture from the refuse, the Ashtec system does not utilize the novel spraying or sensing technology of the present invention. The Integrated Pollution Prevention and Control, “Reference Document on the Best Available Techniques for Waste Incineration” August 2006 also discloses and describes a prior art water-sealed based ash collection. See FIG. 2.5 for example.

In most plants in the United States, Europe and Japan the (bottom) ash is quenched in a water trough at the discharge end of the grate. Walter R. Niessen, “Combustion and Incineration Processes—Applications in Environmental Engineering”, Fourth Edition, CRC Press, 2010. As explained by Stockholm Convention on Persistent Organic Pollutants (POPS), mass burn water wall incinerators are the dominant form of incinerator found at large municipal waste combustion facilities. POPS illustrates a typical schematic of facility using water quench tank for bottom ash http://www.pops.int/documents/meetings/bat_bep/2nd_session/inf10/EGB2_INF10_munwaste_incineration.pdf Solid Waste Management, 2005, describes some of the problems with current incineration technology. For example, the book explains that ash produced by incineration is hot and must be cooled prior to disposal. The normal method of cooling is quenching in water. After quenching, the ash is dewatered to facilitate storage or landfilling on the incinerator site or transport to a remote disposal site. See Part II, Chapter 13, as well as the title page: http://www.unep.or.jp/ietc/publications/spc/solid_waste_management/Vol_I/19-Chapter13.pdf and http://www.unep.or.ip/ietc/publications/spc/solid_waste_management/. The problems associated with conventional water based cooling systems have been known in the art for some time, and until Applicant's proposed solution has eluded inventors. For example, a paper by Cappola and Sunk describes that in a conventional Waste-To-Energy (WTE) power plant, bottom ash is typically discharged into a water quenching tank. The water level provides a seal and prevents ambient air from entering the combustion chamber. Also quenching the bottom ash with water stops combustion immediately and prevents fugitive emissions. However, one of the disadvantages of quenching are the high concentration of water in the ash (up to 30-40%) leading to unnecessary costs of transporting and landfilling water. Furthermore, the wet ash tends to bind like cement and form accretions that adhere on metals thus lowering the value of WTE metals and resulting in the loss of small ferrous and non-ferrous metal pieces. http://www.seas.columbia.edu/earth/wtert/sofos/nawtec/nawtec15/nawtec15-3202.pdf.

### SUMMARY OF THE INVENTION

Aspects of the present invention provide an apparatus, system, and method for adequately cooling bottom ash without immersing the bottom ash in a bath of water. In some embodiments, the ash collector may have a shallow water pool to minimize the generation of fly ash. The water pool maintains 6 inches to 12 inches of water. Preferably about 6-8 inches of water are maintained to provide fly ash suppression without saturating a majority of the ash. The water pool is typically placed in the container of the ash zone, and height of the ash zone may be 8 feet, meaning that a filled ash zone has about 6 inches of saturated ash or about 6.25 percent saturated ash and about 93.75 percent unsaturated ash. Water levels may be maintained by the controller so that they are too low to form a water seal. One way the prior art ash collectors (wet ash collectors) and the invention (dry ash collector) differ is the wet ash collectors primarily use a pool of water to cool the ash, while certain embodiments of the present invention use water sprayers. In addition, wet ash collectors use the pool of water to generate a seal to allow for the generation of negative pressure in the reception zone, whereas certain embodiments of the invention use the ash itself to create the negative pressure seal.

Most combustions systems (including certain embodiments of the present invention) feature a negative pressure source (such as a vacuum) in the system. The negative pressure may be created by an induction draft fan for example. This negative pressure helps keeps fly ash from exiting the system, and it generally pulls combustion gases and air born particles through the boiler and downstream conditioning equipment and out the stack. The ash collector reduces the flow of gases from the beach area to the furnace and maintains a seal in between the beach area and the furnace while removing ash from system. Even though ash is passed through the seal, the ash seal can be maintained. The stack emits heat, water vapor, carbon dioxide, oxygen and other gases into the atmosphere. Certain configurations of ash collectors (including certain embodiments of the present invention) provide an air tight seal at the ash collection zone to maintain negative pressure in the reception zone by preventing air from entering the reception zone and the furnace through the ash collector. Prior art systems accomplished this using a water seal. Mechanical valves and other similar mechanisms cannot provide constant sealing, because they would need to be opened to allow ash to fall through them (thus breaking the seal.) Prior art systems using a water seal also benefit from the water providing the second function of cooling the refuse at the cost of increasing the water content of the ash. One of the purposes of the ash seal is to prevent air flow from the beach area into the furnace. Combustion in the furnace is usually carefully controlled. If a seal is not present in the ash collector, gas may be drawn by the negative pressure source through the ash zone into the furnace disrupting the controlled combustion.

Rather than relying upon water to provide the seal, aspects of the present invention feature an ash seal which is used to maintain negative pressure in the reception zone and other areas of the ash collector. To form the ash seal, ash is allowed to fall and accumulate in the ash zone filling a container until the ash level meets a level specified by a controller. The controller may use an ash sensor to determine ash levels in the container. When the container is filled, air cannot pass through the ash zone because the ash blocks the air flow. In some configurations, ash will also partially fill the beach area, further blocking the passage of air through the ash collector. Because the ash blocks or substantially blocks the flow of air in the ash collector, negative pressure may be maintained in the reception zone.

### BRIEF DESCRIPTION OF THE DRAWINGS

FIG. 1 is a prior art wet bottom ash collector in combination with a grate and a furnace.

FIG. 2 is an embodiment of dry bottom ash collector in combination with a waste refuse combustion system.

### DETAILED DESCRIPTION OF THE DRAWINGS

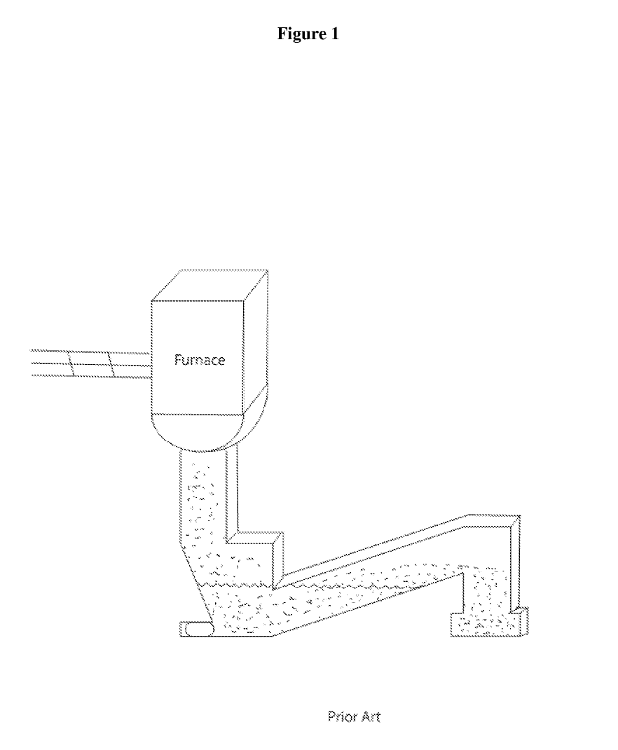

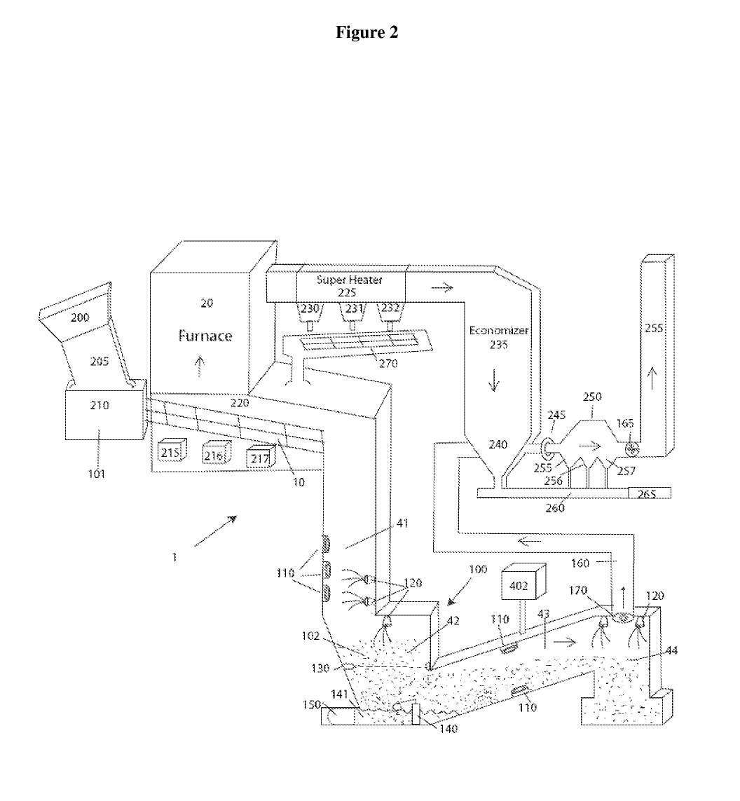

At a very high level, aspects of the present invention relate to an ash collector 100 for a combustion system 1 having a furnace 20. Methods of collecting bottom ash, and using an ash collector are also presented. Starting from the left of FIG. 2, there is an intake 200, a chute 205, a combustor 210, a grate 10, under fire air chambers 215-217, air chamber 220, moving grate 10, a furnace 20, a super heater 225, super heater fly ash collectors 230-232, an economizer 235, a scrubber 245, a baghouse 250, baghouse fly ash collectors 255-257, a negative pressure source 165, a stack 255, an economizer fly ash collector 240, an ash collector port 160, an exhaust fan 170, a fly ash and scrubber solids removal conveyor 260 (used for removing the fly ash and scrubber solids from baghouse 250 while maintaining the negative pressure seal), a conditioner 265 (used to moisten the fly ash with water to prevent dusting), a super heater fly ash conveyor 270, and a dry ash collector 100. FIG. 1 depicts a prior art combustion system containing a grate 10, a furnace 20, and a wet ash collector 30. Details concerning the grate, furnace and other components depicted are described in US Application Publication 2010/0288173, filed May 18, 2009, herein incorporated by reference in its entirety. Although the liquid used to cool the ash is often water (for reasons of cost, availability, etc) other fluids may be used in the present invention.

The arrows on FIG. 2 denote the direction of gas flow. Generally speaking, all gas flows towards the negative pressure source. Municipal waste in the chute 205 and combustor 210 provide a waste seal 101 for maintaining the negative pressure from the negative pressure source 165. An ash seal 102 is formed in the ash zone, preventing the negative pressure source from drawing air and fly ash back into the furnace. Drawing fly ash back into the furnace is undesirable because increasing the fly ash in the system 1, increases fouling and erosion of components like the super heater 225 and economizer 235, air inleakage from the beach area 43 negatively affects combustion control and reduces heat transfer efficiency. and increases the load on the negative pressure source.

FIG. 2 shows a combustion system utilizing a dry ash collector 100. As shown in FIG. 2, the ash collector 100 may contain heat sensors 110, sprayers 120, an ash collector port 160, a ram 150, a pool 141, a negative pressure source 165, a water level detector 140, and an ash detector 130. The ash collector 100 may also contain several zones including a reception zone 41, an ash zone 42, a beach area 43, and a collection zone 44. A zone can be a mechanical housing formed by panels or walls to form a geometric shape having an internal volume for housing ash and system components such as the heat sensor or sprayer. Heat sensors 110 and sprayers 120 may be positioned in any of the zones, but the embodiment of FIG. 2 shows the heat sensors 110 in the receiving zone 41 and beach area 43, with sprayers 120 in the reception zone 41, ash zone 42, and collection zone 44. As shown in the embodiment of FIG. 2, the ram 150, ash detector or ash level sensor 130, and a water sensor or water level detector 140 are in the ash zone 42. The system may also be controlled by one or more controllers or regulators 402, which can control and receive data from components such as the heat sensors 110, sprayers or spray nozzles 120, ash detector 130, water level detector 140, ram, or exhaust fan 170. For example, the controller 402 may be connected to the ash detector for increasing the ash in the ash zone 42 if the ash level in the ash zone is too low to maintain the ash seal by for example increasing the speed of the grate or decreasing the speed of the ram. Controller 402 may have a wired or wireless connection to these components. Controller 402 may contain a microprocessor, computer logic, memory, and software instructions for causing the controller to receive input from components and to cause the controller 402 to send instructions to the components. In some embodiments, controller 402 can also control other elements of the system such as the speed of the grate 10 (or a second ram which pushes items on the grate), the temperature of the furnace 20, etc.

Although embodiments of the ash collector 100 are referred to as a dry ash collector, the ash collector may still comprise a small amount of water at the bottom of the ash zone 42. One purpose of having a small pool of water 141 is to trap smaller particles which have a tendency to fall through larger particles and collect at the bottom of the ash collector and may become airborne. Without this water, the flyable ash may become airborne when the ash exits the ash discharger. A water level detector 140 monitors the amount of water in the ash zone 42, and may send information to the controller 402 regarding the water level. If the controller 402 determines water levels are too low, the controller may cause the sprayer (particularly sprayers in the ash zone 42) to inject more water into the ash zone 42. The sprayers may be connected to a fluid source or water reservoir (not illustrated) for providing fluid or water to the sprayers. A drain may also be added to the ash zone to remove excess water. The water level may range from being only a few inches to about twelve inches depending on the type of waste being combusted. This lower water level helps prevent the ash from collecting excess weight. Some embodiments of the present invention may not contain a water bath 141, but if they do, water levels are kept to a maximum depth of less than 12 inches, and preferably less than 6 inches to avoid soaking too much ash with water.

The heat sensors 110 may be thermocouples. The heat sensors 110 can be used to determine the temperature of ash both in the receiving zone 41 and the beach area 43 (according the FIG. 2 embodiment.) The controller 402 may change the amount, speed, and/or direction of the spray of water to reduce the temperature of the ash if it exceeds a predetermined temperature. Similarly if the temperature of the ash is below a certain level, the controller may change the amount, speed, and/or direction of the spray to avoid adding unnecessary water to the system. Some controllers may alternatively employ equations which directly determine speed, volume, and angle of the ejected water by considering temperature data received by the sensors. Additionally, the controller 402 can also take into account the speed of the grate (or speed of a ram pushing refuse on the grate), temperature inside the furnace 20, and amount of ash falling into the reception zone 41. The amount of ash falling into the reception zone 41 per unit of time is called the ash flow rate. This value may be computed by the controller 402 by for example noting how fast ash is removed from the ash zone 42. If the ram 150 moves the bottom ash at a constant speed, the amount of ash in the ash zone 42 (as measured by the ash detector 130) can be used to determine the ash flow rate entering the reception zone 41. The ash flow rate may also be used by the controller to approximate the temperature of ash falling into the reception zone. In other embodiments, the sole or primary determination of how much and how fast to spray may be determined by the controller's analysis of the ash flow rate. Temperature information received from the temperature sensors 110 may then be analyzed by the controller to fine tune the amount or direction of the sprayers' ejection of water.

The ash sensor 130 may use infrared radiation to detect the amount of ash in the ash zone 42. It is important to maintain a sufficient amount of ash in the ash zone to prevent air inleakage into the furnace 20 from the ash collector 100 and assist in maintaining negative pressure in the reception zone 41 and other areas. To with, the controller 402 may increase the speed of the grate or decrease the speed or movement rate (ash moved per minute) of the ram to maintain the ash seal 102. In the prior art system (see FIG. 1), a water bath was used to maintain an air tight seal. This led to the immersion of the ash, as the ash entered the water, cooling the ash in process. Here (FIG. 2), the ash itself provides the seal. Ash from the bottom of the ash zone 42 can be moved up the beach area by a ram 150, screw, or moving grate. The ram 150 may be hydraulically or mechanically controlled and directed to push the bottom ash up the beach ramp. Some of the excess water may run back down the ramp into the ash zone 42. Temperature sensors 110 may be provided to measure the temperature of the ash in the beach area 43. If the controller 402 determines the ash in the beach area is too hot, it may cause the sprinklers 120 to add additional water to the ash. However, in most configurations, the primary purpose of the sprinklers in the collection zone is suppress the formation of any fly ash. Ash and gases that are not suppressed, may be drawn through the ash collector port 160, where the gas may be distributed to the scrubber 245 and baghouse 250. It is preferable to keep the ash in the ash collector, because increasing the fraction of fly ash passed through the scrubber and baghouse can increase costs and wear of these components. this can reduce overall system performance by increasing the rate of fouling for heat transfer surfaces and burdening the capacity of the flue gas removal equipment including the baghouse 250 and negative pressure source.

Ash falling through the reception zone 41 may contain uneven temperatures. The ash in the center of the reception zone may be hotter and more difficult to expose to water. To explain this in more detail, in an exemplary deployment of the disclosed technology, the reception zone may be a housing 8 feet wide by 4 feet deep by 16 feet long. If the sprayers 110 and 120 are positioned along the perimeter of the housing walls, special techniques will need to be employed to make sure that all ash is sprayed with water otherwise uneven cooling of the ash may occur. To help prevent uneven cooling, the controller 420 may change the direction of the sprayers, the pressure of the water emitted by the sprayers, spray interval, or flow rate of water exiting through the sprayers to maintain a desired temperature range of the ash in the ash zone. Various size nozzles may be used based on ash temperature.

1. A dry ash collector for a combustion system, said ash collector comprising:
a. a reception zone for receiving falling ash from a furnace;
b. an ash zone providing a container for storing falling ash; and
c. an ash seal formed by falling ash filling the ash zone thereby forming a seal to prevent outside air from entering into the reception zone.

2. The ash collector of claim 1 comprising a negative pressure source for creating negative pressure within the ash zone, and said ash seal preventing outside air from entering the ash zone.

3. The ash collector of claim 1 comprising a beach area, collection zone, and negative pressure source for creating negative pressure within the ash zone, and said ash seal preventing outside air from moving through the collection zone, into the beach area, into the ash zone, and into the furnace.

4. The ash collector of claim 1 comprising a beach area, collection zone, and negative pressure source for creating negative pressure within the ash zone, and said ash seal preventing gas flow between the beach area and the furnace.

5. The ash collector of claim 1 comprising a beach area, wherein ash in the beach area and ash in the reception zone form the ash seal.

6. The ash collector of claim 1, wherein the reception zone and ash zone are physical structures formed by panels having a central volume for receiving ash.

7. The ash collector of claim 5, wherein the ash seal has a seal integrity, and a sprayer in the beach area sprays water into the beach area to suppress the formation of fly ash in the beach area to maintain the integrity of the ash seal.

8. The ash collector of claim 1, wherein a water seal is not used to prevent air from passing from the collection zone through the beach area to the reception area.

9. The ash collector of claim 1, comprising a water sensor for determining a water level in a water pool, and a controller connected to the water sensor for increasing or decreasing flow rates of water entering the reception area.

10. The ash collector of claim 9, wherein the water level of the water pool is too low to provide a water seal to maintain negative pressure in the reception zone.

11. The ash collector of claim 9, wherein the water in the water pool does not provide a majority of the cooling of the ash, does not saturate a majority of the ash in the ash zone, and the water pool is positioned with the ash zone.

12. The ash collector of claim 1, comprising spray nozzles for spraying water into the reception area to cool the ash as it falls into the ash zone; said spray nozzles connected to a fluid source for providing water to the spray nozzles, and said spray nozzles providing the primary source of cooling for the ash.

13. The ash collector of claim 1, wherein the ash is not cooled primarily by a water bath.

14. The ash collector of claim 1, comprising an ash level sensor for determining whether there is a sufficient amount of ash in the ash zone to form the seal, and a controller connected to the ash level sensor for increasing the amount of ash in the ash zone if the ash level is too low to maintain the ash seal.

15. The ash collector of claim 1, comprising an ash level sensor for determining whether there is a sufficient amount of ash in the ash zone to form the seal, and a controller connected to the ash level sensor for slowing down the speed or reducing the movement rate of the ram so that an adequate amount of ash is maintained in the beach area to maintain the ash seal.

16. The ash collector of claim 1 comprising a heat sensor in the reception zone for determining temperature information of falling ash in the ash collector; said heat sensor connected to a controller, said controller increasing or decreasing a flow rate or spray interval of water depending on temperature information received from the heat sensor.

17. A method for collecting dry ash comprising the steps of:
a. receiving falling ash from a furnace at a reception zone;
b. providing an ash zone, said ash zone being a container for storing falling ash; and
c. forming an ash seal by positioning the falling ash so that it fills the ash zone thereby forming a seal to prevent outside air from entering into the reception zone or furnace.

18. The method of claim 17 comprising the steps of: providing a negative pressure source for creating negative pressure within the ash zone, and preventing gas flow between the ash collector and the furnace with an ash seal.

19. A combustion system comprising a dry ash collector and a furnace: said dry ash collector comprising:
a. a reception zone for receiving falling ash from the furnace;
b. an ash zone providing a container for storing falling ash; and
c. an ash seal formed by falling ash filling the ash zone thereby forming a seal to prevent outside air from entering into the reception zone.

20. The system of claim 19 comprising a negative pressure source for creating negative pressure within the system, and an ash seal for preventing gas flow between the ash collector and the furnace.
